(19) United States
(12) Patent Application Publication
(10) Pub. No.: US 2014/0233614 A1
(43) Pub. Date: Aug. 21, 2014

(54) ISOLATION COMMUNICATION TECHNOLOGY USING COUPLED OSCILLATORS/ANTENNAS

(71) Applicant: FAIRCHILD SEMICONDUCTOR CORPORATION, SAN JOSE, CA (US)

(72) Inventor: Philip J. Crawley, Oceanside, CA (US)

(73) Assignee: FAIRCHILD SEMICONDUCTOR CORPORATION, SAN JOSE, CA (US)

(21) Appl. No.: 14/184,867

(22) Filed: Feb. 20, 2014

Related U.S. Application Data
(60) Provisional application No. 61/767,074, filed on Feb. 20, 2013.

(51) Int. Cl. H04B 1/40

(52) U.S. Cl. CPC H04B 1/40
USPC 375/219

(57) ABSTRACT

The present subject matter discusses, among other things, electrical isolation, and more particularly wireless electrical isolation methods and apparatus. IN an example, an electrical isolator can include a transmit circuit including a transmit antenna, and a receive circuit including a receive antenna. The transmit circuit can be configured to receive digital data and to modulate a transmit signal with the digital data, and to transmit the transit signal using the transmit antenna. The receive antenna can be configured to receive the transmit signal and to demodulate and provide the digital data from the transmit signal using a demodulation clock signal.

### CLAIM OF PRIORITY AND RELATED APPLICATIONS

This application claims the benefit of priority under 35 U.S.C. §119(e) of Philip J. Crawley, U.S. Provisional Application Ser. No. 61/767,074, titled, “ISOLATION COMMUNICATION TECHNOLOGY USING COUPLED OSCILLATORS/ANTENNAS,” filed on Feb. 20, 2013, U.S. which hereby is incorporated by reference herein in its entirety.

### BACKGROUND

Existing technologies to communicate across an isolation barrier include opto-couplers and digital isolation technologies. Optical couplers worked well and meet the requirement of isolation testing at the component level, but are not particular reliable or fast. In addition, optical couplers lack benefits provided by CMOS technologies whereby cost and size improves with each generation of technology. Existing digital isolators can provide improved speed and reliability over optical couplers but are not capable of being tested for compliance to component level standards of isolation. In addition, existing isolators that employ transformers transfer significant energy between isolation components compared to the low power, digital, isolators described below.

### OVERVIEW

The present subject matter discusses, among other things, electrical isolation, and more particularly wireless electrical isolation methods and apparatus. In an example, an electrical isolator can include a transmit circuit including a transmit antenna, and a receive circuit including a receive antenna. The transmit circuit can be configured to receive digital data and to modulate a transmit signal with the digital data, and to transmit the transit signal using the transmit antenna. The receive antenna can be configured to receive the transmit signal and to demodulate and provide the digital data from the transmit signal using a demodulation clock signal.

This overview is intended to provide a non-exclusive summary of the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates generally an example digital isolator.

FIG. 1B illustrates generally an example multi-channel, bi-directional digital isolator.

FIG. 2 illustrates a top down view of an example digital isolator.

FIG. 3A illustrates a top down view of an example digital isolator with loop antennas facing each other.

FIG. 3B illustrates generally a cross section of a loop antenna illustrated in FIG. 3A.

FIG. 4 illustrates generally an example amplitude modulated (AM) digital isolator.

FIG. 5 illustrates an example AM digital isolator that allows the transmitter to operate without a separate oscillator.

FIG. 6 illustrates generally an integrated circuit package including a waveguide structure for coupling the isolated components of an example digital isolator.

FIG. 7 illustrates generally an integrated circuit package including an example meandering inductor/antenna structure.

FIG. 8 illustrates generally an example digital isolator including dipole antennas.

FIG. 9 illustrates generally an example digital isolator including end-loaded dipole antennas.

### DETAILED DESCRIPTION

This application discusses, among other things, methods and apparatus for communicating across an isolation barrier and more particularly, methods and apparatus for communicating across an isolation barrier that allows one to test isolation compliance at the component level without significant energy transfer between isolation components. Existing opto-coupler technology allows isolation testing at the component level, but is not particularly reliable or fast. In addition, opto-coupler technology does not provide the benefit of CMOS technologies whereby cost and size can improve with each generation of the technology. Existing digital isolators that rely in dielectric isolation can provide speed and reliability but does not provide the capability of being tested for full component level compliance with standards of isolation.

The present inventors have recognized an electrical isolation technology that can remove the need for a dielectrically isolated device, e.g., capacitor or transformer, can provide the speed and reliability, and can provide the capability of being tested for full component level isolation compliance. The technology can be used, in certain examples, to communicate digital data between high voltage and low voltage portions of a system. For example, the technology can be used to communicate data between two integrated circuits that except for the isolation technology are electrically isolated from each other. The technology can include a wireless implementation via coupled oscillators. Transmission of data can be accomplished via injection locking coupled oscillators, wherein a transmitting side (TX) can be driven to a known frequency via digital input control and the receiving side (RX) can lock to the known frequency and can demodulate the data. In certain examples, injection locking coupled oscillators can take advantage of the benefits of CMOS technology and still be able to meet isolation standards at the component level. The technology can be used in many applications including but not limited to, power conversion, isolated gate drivers, high-speed digital isolators, and current sensors.

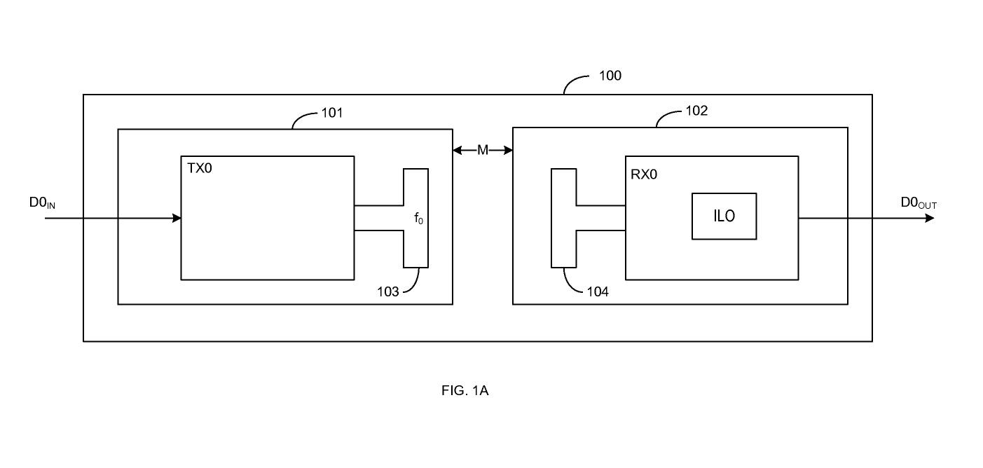

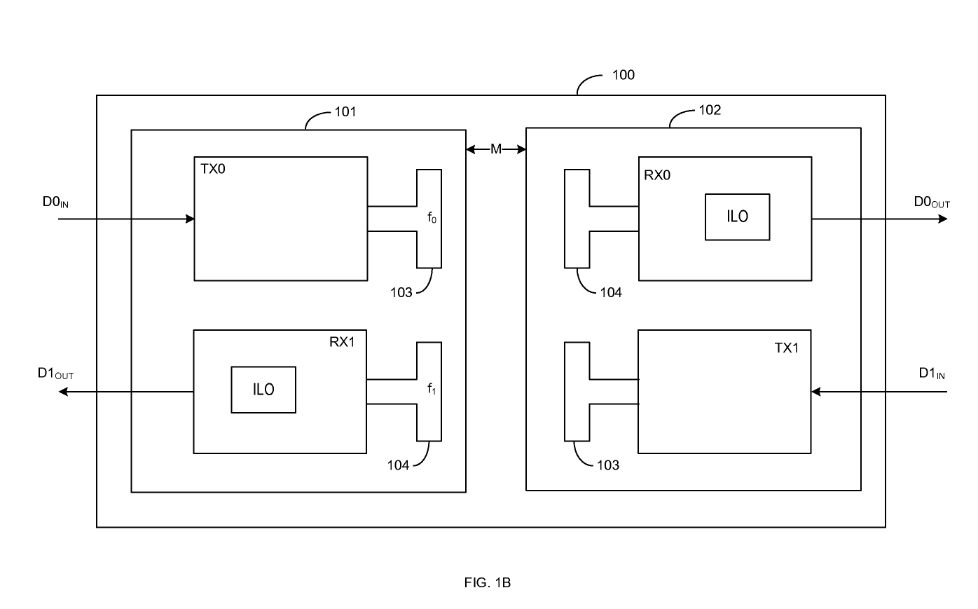

FIG. 1A illustrates generally an example digital isolator 100. The digital isolator 100 can include first and second integrated circuits or chips 101, 102 separated by a distance (M). In certain examples, the first integrated circuit chip 101 can include a transmitter circuit (TX0) and the second integrated circuit chip 102 can include a wireless receiver circuit (RX0). Incoming digital signals (D0_{IN}) can be modulated at a t a first carrier frequency using a phased locked loop (not shown). In certain examples, the frequency can be in the gigahertz range, but other ranges are possible and can depend on the application and the technology used. In certain examples, a transmit antenna, such as a single loop transmit inductor 103, 104 can be coupled to the transmitter circuit (TX0) and a receive antenna, such as a single loop receive inductor 104, can be coupled to the receiver circuit (RX0). In certain examples, the receiver circuit can include an injection locked oscillator (ILO).

In certain examples, the digital isolator 100 can be used to communicate information from a first integrated circuit to a second integrated circuit. The isolation function of the digital isolator 100 can be very useful where electrical isolation between, for example, a high-voltage first integrated circuit and a second low-voltage integrated circuit. Transmission of received data (D0_{IN}) can be performed via injection locking coupled oscillators, wherein transmitter circuit (TX0) is driven to a predetermined frequency via digital input control and the receiver circuit (RX0) can lock onto the predetermined frequency and demodulate output data (D0_{OUT}).

FIG. 1B illustrates generally an example multi-channel, bi-directional digital isolator 100. The digital isolator 100 can include first and second integrated circuit chips 101, 102 separated by a distance (M). In certain examples, each chip 101, 102 can include a wireless transmitter circuit (TX0, TX1) and a wireless receiver circuit (RX0, RX1). Incoming digital signals (D0_{IN}, D1_{IN}) can be modulated at multiple frequencies (f₀, f₁) using a phased locked loop of each transmitter circuit (TX0, TX1). In certain examples, the frequencies can be in the gigahertz range, but other ranges are possible and can depend on the application and the technology used. Each receiver circuit (RX0, RX1) and transmitter circuit (TX0, TX1) can include an antenna, such as a single loop inductor. Coupling between a transmitter inductor and a receiver inductor can allow the receiver oscillator to lock on to the transmitter circuit frequency and demodulate the digital data. In certain examples, instead of using magnetically coupled single loop antennas, a digital isolator can use resonant antennas to create and maintain a communication link between the two side of the digital isolator. In certain examples, the use of resonant antennas can simplify transmit or receiver circuits eliminating one or more amplifiers or filters. In certain examples, the complex impedance of the resonant transmit and receiver circuit can be matched to each other rather than to an arbitrary standard, such as a 50 ohm termination standard, to provide more efficient communication coupling of the circuits. Such coupling can significantly reduce the power consumption of the circuits especially if an injection-lock oscillator scheme is used as such schemes do not transmit as much energy as existing transformer isolation schemes. Examples of some resonant antennas is discussed below.

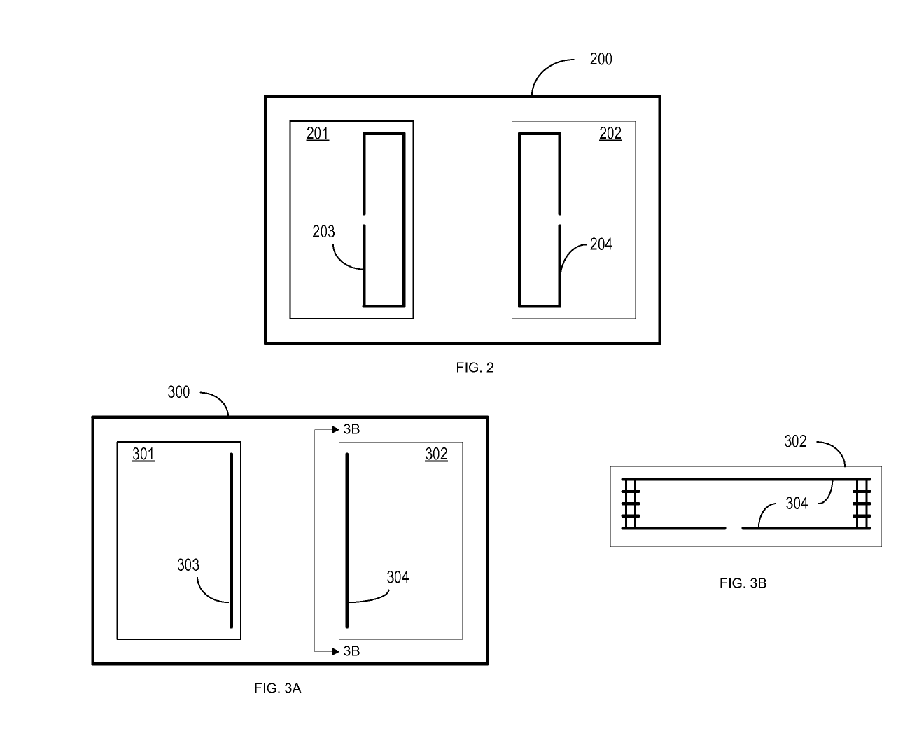

FIG. 2 illustrates a top down view of an example digital isolator 200. The digital isolator 200 can include a transmitter single loop inductor 203 on a top surface of the first integrated circuit 201 and a receiver single loop indictor 204 on a top surface of the second integrated circuit chip 202. FIG. 3A illustrates a top down view of an example digital isolator 300 with loop antennas 303, 304 facing each other. In certain examples, the digital isolator 300 can include a first integrated circuit chip 301 and a second integrated circuit chip 302. The loop antennas 303, 304 can be fabricated into the layers of each respective chip such that the loops face each other for more direct coupling. FIG. 3B illustrates generally a cross section of a loop antenna 304 illustrated in FIG. 3A. In certain examples, the digital isolator 300 can include a transmitter single loop inductor 303 on a side surface of the first integrated circuit chip 301 and a receiver single loop inductor 304 on a side surface of the second integrated circuit chip 302. In certain examples, a single loop inductor can provide high self-resonance frequencies. In some examples, a narrow single loop can provide lower self-inductance relative to mutual inductance. In certain examples, the integrated fabrication of the single loop with the integrated circuit chips can take advantage of standard CMOS fabrication processes for fabricating the integrated circuit chips.

In certain examples, each side of the digital isolator can include a voltage controlled oscillator (VCO) coupled to an antenna/inductor for modulating the digital data communicated between the different halves of the isolator. In certain examples, the injection locking range of a digital isolator can be limited. In some examples, the inject locking range can be limited based on the following formula:

$$\vert 2 Q \frac{E}{{E}_{1}} \cdot \frac{{Δω}_{0}}{{ω}_{0}} \vert < 1 ,$$

where E can be the voltage of the self-oscillating receiver loop, and E₁ can be the induced voltage from the transmit antenna/inductor/coil. In certain examples, the coupling coefficient can be very low (e.g., 1-4%). If Q=7, for a 15 gigahertz (GHz) carrier, the locking range can be between about 10 megahertz (MHz) and about 40 MHz. In certain examples, direct current (DC) components can be rejected and other harmonics greatly attenuated by a phased-lock loop (PLL) filter, thus creating a very narrow band system in the locking range. In certain examples, the system can exchange data using amplitude modulation (AM). In some examples, an AM digital isolator having the same frequency selectivity of the FM digital isolator described above can include a low noise amplifier having a Q greater than 500.

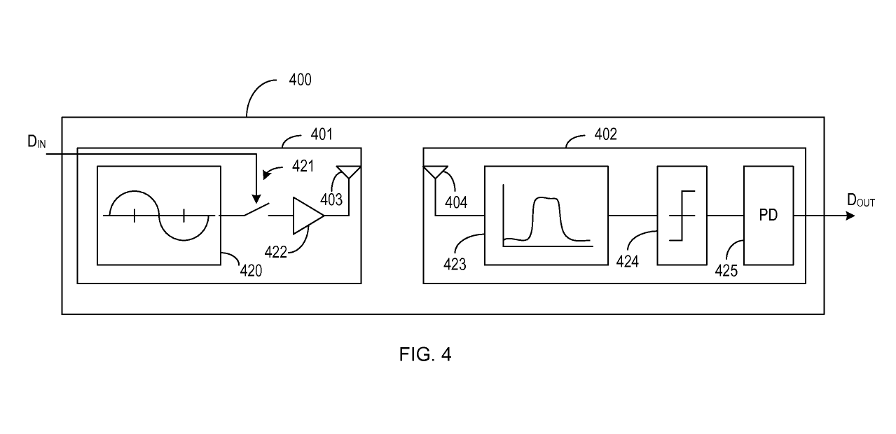

FIG. 4 illustrates generally an example AM digital isolator 400 including a transmitter circuit 401 and a receiver circuit 402. In certain examples, the transmitter circuit 401 can include a transmit oscillator 420, a modulation switch 421 such as a transistor, a power amplifier 422, and an antenna 403 or inductor. In certain examples, the modulation switch can be controlled by the input digital data D_{IN}. In certain examples, the receiver circuit 402 can include an antenna 404 or inductor, a low noise amplifier 423, a non-linear filter 424 and a power detector 425. In certain examples, the low noise amplifier 423 can be tuned as a band-pass filter about the transmit frequency. The non-linear filter 424 can provide a DC-level signal that the power detector 425 can use to provide the digital output information (D_{OUT}). The transmitter 401 and receiver 402, including the antennas 403, 404 can be separated physically from each other to provide electrical isolation between corresponding circuits coupled to the transmitter circuit 401 and receiver circuit 402. The illustrated 1 mm separation is one example of a separation distance. In certain examples, the separation distance can be more or less than 1 mm. without departing from the scope of the present subject matter. In certain examples, the digital isolator includes encapsulation materials encapsulating together the transmitter circuit 401 and the receiver circuit 402.

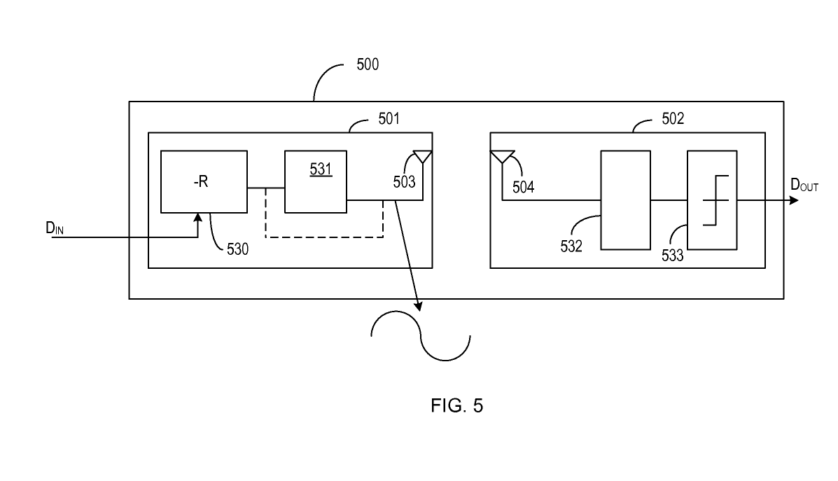

FIG. 5 illustrates an example AM digital isolator that allows the transmitter to operate without a separate oscillator and the receiver to operate without a low noise amplifier. The transmitter can include an impedance transforming circuit and antenna driven with a negative impedance to maintain self-oscillation. The frequency of the self-oscillation can be designed to be at or near the maximum coupling frequency of the isolator. The negative impedance can be enabled/disabled with the digital data. In certain examples, the example isolation circuit can be implemented with a reduced number of components.

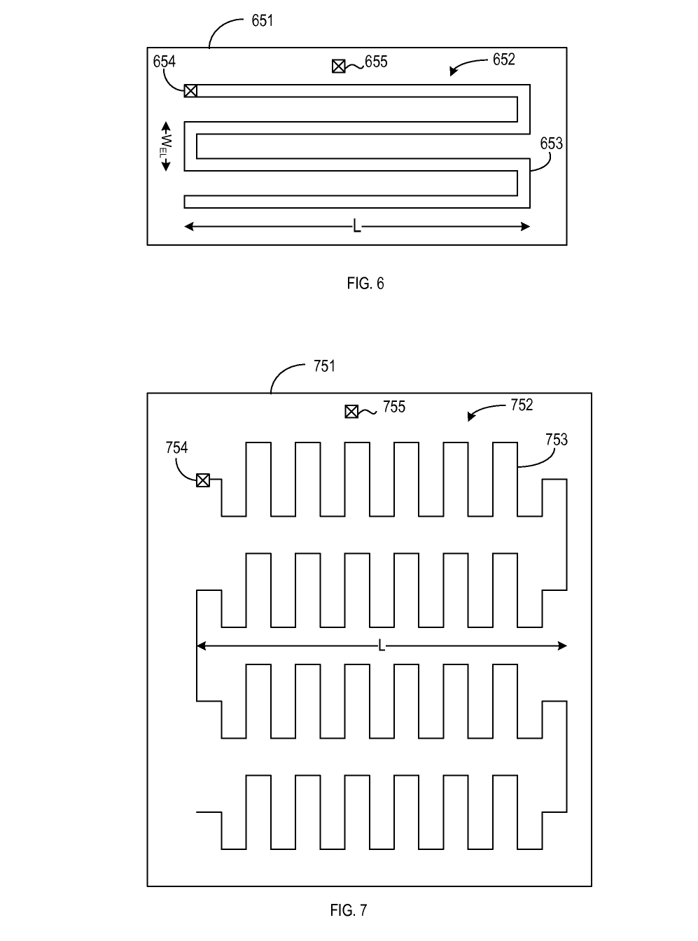

FIG. 6 illustrates generally an integrated circuit package 651 including a waveguide structure 652 for coupling the isolated components of an example digital isolator. The waveguide structure 652 can be fabricated on a side or top of one or more of the transmitter integrated circuit or the receiver integrated circuit of the digital isolator. In certain examples, the waveguide structure 652 can include the waveguide trace 653 and first and second ports 654, 655 for coupling the waveguide structure 652 to the transmitter circuit or the receiver circuit. The multi-turn components of the waveguide structure can ameliorate field cancellation effects that can be prevalent in the loop structures illustrated in FIGS. 2, 3A, and 3B when the length of each turn is significant with respect to signal wavelength. The ground return plane can ensure that fields are kept between the coil and the plane, where dielectric constant is higher and thus wave propagation time is longer. In certain examples, the length of the waveguide trace can be less than 1 mm. In some examples, the length of the waveguide trace can be one the order of 1/16 of wireless signal wavelength. In some examples, the loop end width (W_{EL}) dimension can be from 1/20^{th} to ¼ of the length (L) of the waveguide trace.

FIG. 7 illustrates generally an integrated circuit package 751 including an example meandering inductor/antenna structure 752 for coupling the isolated components of an example digital isolator such as the example digital isolators of FIGS. 1A, 1B, 4 and 5. The meandering inductor/antenna structure 752 can be fabricated on a side or top of one or more of the transmitter integrated circuit or the receiver integrated circuit of the digital isolator. In certain examples, the meandering inductor/antenna structure 752 can include the meandering trace 753 and first and second ports 754, 755 for coupling the meandering inductor/antenna structure to the transmitter circuit or the receiver circuit. In certain example, a meandering inductor/antenna structure can be extended to enable larger phase shift in the transmit wave and the receive wave as the wave reaches the end of each row. In certain examples, self-inductance of each back and forth in a row can be cancelling. In certain examples, first order self-inductance can be set by the length L. Greater phase shift, in some examples, can enable greater mutual inductive coupling. In certain examples, a meandering inductor/antenna structure 732 can keep a wave travelling along underneath the metal trace (over the ground plane) to improve coupling.

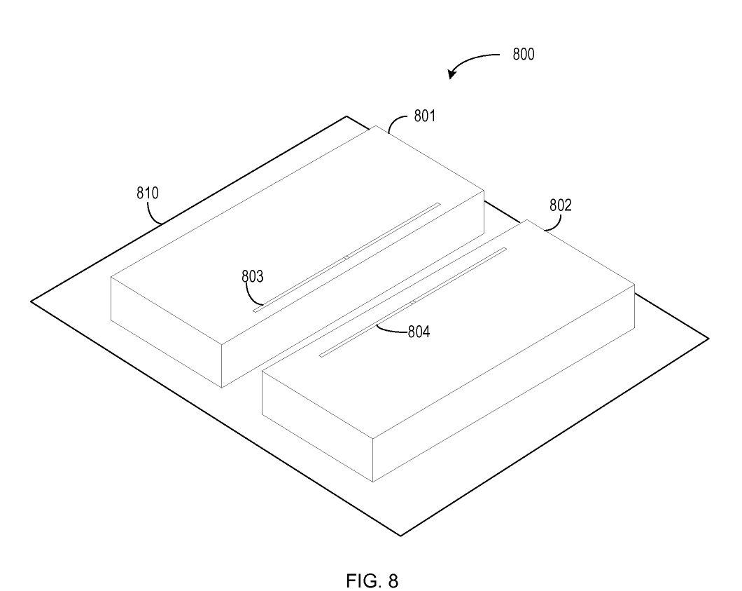

FIG. 8 illustrates generally an example digital isolator 800 including dipole antennas 803, 804. In certain examples, the digital isolator 800 can include a insulative substrate 810, a first integrated circuit 801 and a second integrated circuit 802. In certain examples, the first integrated circuit 801 can include a transmitter and the second integrated circuit 802 can include a receiver. In general, a digital isolator according to the present subject matter can be used in an electronic device to communicate information between two circuits or portions of the electronic device while maintaining electrical isolation between the two circuits or portions. In certain examples, a dipole antenna can be used with the example circuits of FIGS. 1A, 1B, 4 and 5. In some examples, the dipole antenna, or resonant dipole antenna, can form part of the oscillator of the corresponding communication component of which it forms, such as the transmitter or the receiver of the example circuits of FIGS. 1A, 1B, 4 and 5. In such a configuration, the dipole antenna can eliminate some communication components associated with a non-resonating antenna and can save considerable die space. In certain examples, the dipole antennas 803, 804 can have a length less than 1 mm. In some examples, the dipole antennas can be about 0.25 mm in length or less.

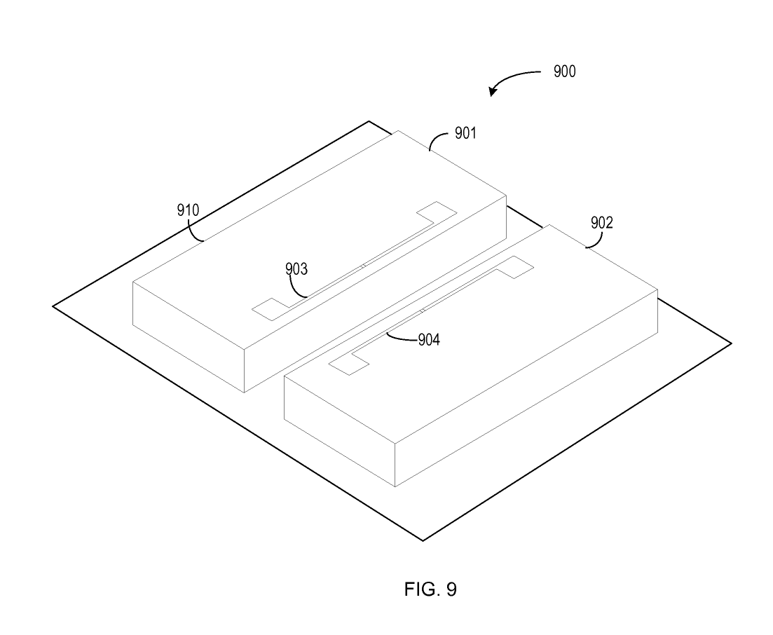

FIG. 9 illustrates generally an example digital isolator 900 including end-loaded dipole antennas 903, 904. In certain examples, the digital isolator 900 can include a substrate 910, a first integrated circuit 901 and a second integrated circuit 902. In certain examples, the first integrated circuit 801 can include a transmitter and the second integrated circuit 802 can include a receiver. In general, a digital isolator according to the present subject matter can be used in an electronic device to communicate information between two circuits or portions of the electronic device while maintaining electrical isolation between the two circuits or portions. Additionally, in certain examples, the components of the digital isolators shown in FIGS. 1A, 1B, 4, 5, 8, and 9 can include a encapsulation material to encapsulate and protect the components of the digital isolator and to provide the connection terminals to external circuitry. In certain examples, an end-loaded dipole antenna 903, 904 can be used with the example circuits of FIGS. 1A, 1B, 4 and 5. In some examples, the end-loaded dipole antenna, or resonant end-loaded dipole antenna, can form part of the oscillator of the corresponding communication component of which it forms, such as the transmitter or the receiver of the example circuits of FIGS. 1A, 1B, 4 and 5. In such a configuration, the end-loaded dipole antenna can eliminate some communication components associated with a non-resonating antenna and can save considerable die space. In certain examples, the dipole antennas 803, 804 can have a length less than 1 mm. In some examples, the dipole antennas can be about 0.25 mm in length or less.

In general, example digital isolators can be fabricated as a system and can include one or more transmitters and one or more corresponding receivers to form a self-contained wireless communication system. A benefit of such a system is the ability for a designer to impedance match each receiver circuit to the corresponding transmitter circuit, or vice versa, instead of matching the impedance of a transmitter or receiver to an industry standard, such as 50 ohms, for example. As such, the communication system can be designed to minimize space while maintain speed, and reliability. By not limiting the impedance of the components of a digital isolator to a specific termination impedance, the antennas can be quite small and still provide the needed performance for communication as well as accommodating the physical spacing to maintain electrical isolation.

Unlike opto-couplers that can be sensitive to extreme temperatures, the example digital isolators can provide robust isolation and data communication over a wide range of temperature. In certain examples, a first and second integrated circuits can form an example digital isolator. Each integrated circuit can include a die including the circuitry and an antenna separated from the circuitry using an insulative material such as a polymide. Such a structure can save die space by stacking the antenna and the isolator circuitry instead of using die space for the antenna.

### ADDITIONAL NOTES

In Example 1, an electrical isolator can include a transmit circuit including a transmit antenna, the transmit circuit configured to receive digital data and to modulate a transmit signal with the digital data, and to transmit the transit signal using the transmit antenna, the transmit signal having a first nominal frequency and a receive circuit mechanically coupled to the transmit circuit, the receive circuit including a receive antenna configured to receive the transmit signal, the receive circuit is configured to demodulate and provide the digital data from the transmit signal using a demodulation clock signal.

In Example 2, the receive circuit of Example 1 optionally includes an injection-locked oscillator configured to receive the transmit signal and to lock on to the first nominal frequency to provide the demodulation clock signal.

In Example 3, the injection-locked oscillator of any one or more of Examples 1-2 optionally includes the receive antenna.

In Example 4, the transmit antenna of any one or more of Examples 1-3 optionally is separated from the receive antenna by about 1 millimeter or less.

In Example 5, a first integrated circuit die optionally includes the transmit circuit of any one or more of Examples 1-4, a second integrated circuit die optionally includes the receive circuit of any one or more of Examples 1-4, and

the electrical isolator of any one or more of Examples 1-4 optionally includes a single encapsulation including the first integrated circuit die and the second integrated circuit die.

In Example 6, the transmit antenna of any one or more of Examples 1-5 optionally includes a single loop inductor antenna.

In Example 7, the transmit antenna of any one or more of Examples 1-6 optionally includes a dipole antenna.

In Example 8, the transmit antenna of any one or more of Examples 1-7 optionally includes an end-loaded dipole antenna.

In Example 9, the transmit circuit of any one or more of Examples 1-8 optionally includes a transmit oscillator, and the transmit oscillator optionally includes the transmit antenna.

In Example 10, the receive antenna of any one or more of Examples 1-9 optionally includes a single loop inductor antenna.

In Example 11, the receive antenna of any one or more of Examples 1-10 optionally includes a dipole antenna.

In Example 12, the receive antenna of any one or more of Examples 1-11 optionally includes an end-loaded dipole antenna.

In Example 13, the first nominal frequency of any one or more of Examples 1-12 optionally is above 8 gigahertz (GHz).

In Example 14, the first nominal frequency of any one or more of Examples 1-13 optionally is between about 8 gigahertz (GHz) and about 40 GHz.

In Example 15, a system can include a first circuit, a second circuit adjacent and mechanically coupled to the first circuit, and an electrical isolator configured to provide a communication path between the first circuit and the second circuit and to maintain electrical isolation between the first circuit and the second circuit, wherein the electrical isolator can include a first transmit circuit including a first transmit antenna, the transmit circuit configured to receive first digital data from the first circuit and to modulate a first transmit signal with the first digital data, and to transmit the first transit signal using the first transmit antenna, the first transmit signal having a first nominal frequency, and a first receive circuit including a first receive antenna configured to receive the first transmit signal and to demodulate and provide the first digital data to the second circuit using a first demodulation clock signal, and a first injection-locked oscillator configured to receive the first transmit signal and to lock on to the first nominal frequency to provide the first demodulation clock signal.

In Example 16, the electrical isolator of any one or more of Examples 1-15 optionally includes a second transmit circuit including a second transmit antenna, the transmit circuit configured to receive second digital data from the second circuit and to modulate a second transmit signal with the second digital data, and to transmit the second transit signal using the second transmit antenna, the second transmit signal having a second nominal frequency and a second receive circuit including a second receive antenna configured to receive the second transmit signal and to demodulate and provide the second digital data to the first circuit using a second demodulation clock signal, and a second injection-locked oscillator configured to receive the second transmit signal and to lock on to the second nominal frequency to provide the second demodulation clock signal.

In Example 17, a first integrated circuit die can include the first transmit circuit and the second receive circuit, a second integrated circuit die can include the second transmit circuit and the first receive circuit, and the electrical isolator of any one or more of Examples 1-16 optionally includes a single encapsulation including the first integrated circuit die and the second integrated circuit die.

In Example 18, at least one of the first transmit antenna and the second transmit antenna of any one or more of Examples 1-17 optionally include an end-loaded dipole antenna.

In Example 19, at least one of the first receive antenna and the second receive antenna of any one or more of Examples 1-18 optionally include an end-loaded dipole antenna.

In Example 20, an electrical isolator can include a transmit circuit including a transmit antenna, the transmit circuit configured to receive digital data and to modulate a transmit signal with the digital data, and to transmit the transit signal using the transmit antenna, the transmit signal having a first nominal frequency, and a receive circuit including a receive antenna configured to receive the transmit signal and to demodulate and provide the digital data from the transmit signal using a demodulation clock signal, and wherein at least one of the transmit antenna or the receive antenna include a resonant dipole antenna.

In Example 21, the resonant dipole antenna of any one or more of Examples 1-20 optionally includes an end-loaded dipole antenna.

In Example 22, the transmit circuit of any one or more of Examples 1-21 optionally includes an amplitude modulated (AM) transmit circuit.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An electrical isolator comprising:
a transmit circuit including a transmit antenna, the transmit circuit configured to receive digital data and to modulate a transmit signal with the digital data, and to transmit the transit signal using the transmit antenna, the transmit signal having a first nominal frequency;
a receive circuit mechanically coupled to the transmit circuit, the receive circuit including a receive antenna configured to receive the transmit signal, the receive circuit is configured to demodulate and provide the digital data from the transmit signal using a demodulation clock signal.

2. The electrical isolator of claim 1, wherein the receive circuit includes an injection-locked oscillator configured to receive the transmit signal and to lock on to the first nominal frequency to provide the demodulation clock signal.

3. The electrical isolator of claim 2, wherein the injection-locked oscillator includes the receive antenna.

4. The electrical isolator of claim 1, wherein the transmit antenna is separated from the receive antenna by at least 1 millimeter.

5. The electrical isolator of claim 1, wherein a first integrated circuit die includes the transmit circuit;
wherein a second integrated circuit die includes the receive circuit; and
wherein the electrical isolator includes a single encapsulation including the first integrated circuit die and the second integrated circuit die.

6. The electrical isolator of claim 1, wherein the transmit antenna includes a single loop inductor antenna.

7. The electrical isolator of claim 1, wherein the transmit antenna includes a dipole antenna.

8. The electrical isolator of claim 1, wherein the transmit antenna includes an end-loaded dipole antenna.

9. The electrical isolator of claim 1, wherein the transmit circuit includes a transmit oscillator; and
wherein the transmit oscillator includes the transmit antenna.

10. The electrical isolator of claim 1, wherein the receive antenna includes a single loop inductor antenna.

11. The electrical isolator of claim 1, wherein the receive antenna includes a dipole antenna.

12. The electrical isolator of claim 1, wherein the receive antenna includes an end-loaded dipole antenna.

13. The electrical isolator of claim 1, wherein the first nominal frequency is above 8 gigahertz (GHz).

14. The electrical isolator of claim 1, wherein the first nominal frequency is between about 8 gigahertz (GHz) and about 40 GHz.

15. A system comprising:
a first circuit;
a second circuit adjacent and mechanically coupled to the first circuit; and
an electrical isolator configured to provide a communication path between the first circuit and the second circuit and to maintain electrical isolation between the first circuit and the second circuit;
wherein the electrical isolator includes:
a first transmit circuit including a first transmit antenna, the transmit circuit configured to receive first digital data from the first circuit and to modulate a first transmit signal with the first digital data, and to transmit the first transit signal using the first transmit antenna, the first transmit signal having a first nominal frequency; and
a first receive circuit including:
a first receive antenna configured to receive the first transmit signal and to demodulate and provide the first digital data to the second circuit using a first demodulation clock signal; and
a first injection-locked oscillator configured to receive the first transmit signal and to lock on to the first nominal frequency to provide the first demodulation clock signal.

16. The system of claim 15, wherein the electrical isolator includes:
a second transmit circuit including a second transmit antenna, the transmit circuit configured to receive second digital data from the second circuit and to modulate a second transmit signal with the second digital data, and to transmit the second transit signal using the second transmit antenna, the second transmit signal having a second nominal frequency; and
a second receive circuit including:
a second receive antenna configured to receive the second transmit signal and to demodulate and provide the second digital data to the first circuit using a second demodulation clock signal; and
a second injection-locked oscillator configured to receive the second transmit signal and to lock on to the second nominal frequency to provide the second demodulation clock signal.

17. The system of claim 16, wherein a first integrated circuit die includes the first transmit circuit and the second receive circuit;
wherein a second integrated circuit die includes the second transmit circuit and the first receive circuit; and
wherein the electrical isolator includes a single encapsulation including the first integrated circuit die and the second integrated circuit die.

18. The system of claim 16, wherein at least one of the first transmit antenna and the second transmit antenna include an end-loaded dipole antenna.

19. The system of claim 16, wherein at least one of the first receive antenna and the second receive antenna include an end-loaded dipole antenna.

20. An electrical isolator comprising:
a transmit circuit including a transmit antenna, the transmit circuit configured to receive digital data and to modulate a transmit signal with the digital data, and to transmit the transit signal using the transmit antenna, the transmit signal having a first nominal frequency; and
a receive circuit including a receive antenna configured to receive the transmit signal and to demodulate and provide the digital data from the transmit signal using a demodulation clock signal; and
wherein at least one of the transmit antenna or the receive antenna include a resonant dipole antenna.

21. The electrical isolator of claim 20, wherein the resonant dipole antenna includes an end-loaded dipole antenna.

22. The electrical isolator of claim 20, wherein the transmit circuit includes an amplitude modulated (AM) transmit circuit.
